(19) United States
(12) Patent Application Publication
(10) Pub. No.: US 2004/0158746 A1
(43) Pub. Date: Aug. 12, 2004

(54) Automatic log-in processing and password management system for multiple target web sites

(76) Inventors: Limin Hu, Fremont, CA (US); Ting-Hu Wu, Fremont, CA (US)

Correspondence Address: Dergosits & Noah LLP, Suite 1450, Four Embarcadero Center, San Francisco, CA, 94111, US

(21) Appl. No.: 10/359,973

(22) Filed: Feb. 7, 2003

(51) Int. Cl. H04L 9/00

(52) U.S. Cl. 713/202

(57) ABSTRACT

An automatic log-in and password management system for on-line, electronic commerce systems is described. An automatic log-in module receives relevant transaction information from a user and processes this information for transactions to one or more target computers. The log-in procedure for access to a secure area within the target computer is stored as a script executable by the password management system. The processing system monitors user accesses to a target computer of the one or more target computers. A password management system detects a password entry requirement to initiate the transaction. The password management system accesses the appropriate password from a pre-stored database to obtain the password corresponding to the user identifier for the specific target client computer. The password management system then executes the stored log-in script and automatically populates the password or other access code into the appropriate access program of the client computer based on the user identifier.

### CROSS-REFERENCE TO RELATED APPLICATIONS

This application is related to U.S. application Ser. No. 10/172,844, entitled “Online System for Fulfilling Loan Applications from Loan Originators”, filed on Jun. 14, 2002, and which is assigned to the assignee of the present application. The disclosure of said application is incorporated herein by reference.

### FIELD OF THE INVENTION

The present invention relates generally to computer networks, and more specifically, to a system for automatically logging in to one or more password protected target computers from a user computer.

### BACKGROUND OF THE INVENTION

The World Wide Web (“web”) has evolved from first generation web systems that simply provide information to client computers over the Internet, to second generation systems using application servers that provide dynamic, personalized information and powerful back-end transaction processing.

A great number of commercial applications have been adapted to on-line embodiments over client/server computer systems, thus establishing a base of many different types of electronic commerce or “e-commerce” applications. Such e-commerce applications often involve the transfer of sensitive data, such as personal, business, and financial information between client and server computers over the Internet. Some applications and on-line vendors also require or prefer users to set up virtual accounts to facilitate on-line e-commerce transactions. To ensure the protection of such account data and/or the sensitive data transferred over the network, computer implemented security measures are often employed to guard against intrusion. Such measures range from sophisticated encryption schemes to simple filtering mechanisms. One popular protection scheme is the use of unique user identifiers and password protection to limit access to on-line accounts and data transfers to only authorized users.

In order to maintain the secrecy of account information and integrity of personal or sensitive data, users are typically advised to create unique user identification (ID) names and secret passwords. The user ID name creates a unique account for the user on a server computer, and the password validates the user name that is recognized by the server computer system administrator. In order to log-in to a particular computer or website, a typical log-in procedure requires the user to input both the user name and the corresponding password.

In many e-commerce environments, an active computer user may have several different accounts with different on-line vendors. For example, a user can have one account with an on-line bank, another account with an on-line travel agent, and further accounts with other service providers, such as a bill paying service, on-line retailer, on-line auction site, and so on. In order to ensure maximum security, a user should select different user ID names and passwords for each different account. In this manner, each separate account is protected in the event that the user ID and password for one account is discovered by an unauthorized third party. However, maintaining different user identifiers and passwords can become difficult and cumbersome for users who interact with several different on-line sites. Without a convenient system for managing these different passwords and access codes, users may simply adopt a single user ID and password for all of their different accounts and applications. This severely compromises the security of these accounts, since a person who breaks the password for one account can then often access the user's other accounts.

A further disadvantage with present network systems involving several different target computers accessed by a single user is that each target computer typically requires a unique log-in or access procedure depending upon the type of account that is established. For example, most secure web sites require that the user type in a log-in name and password. Some web sites however, may require more process steps or different information to allow access to a user account. Furthermore, different web sites may require such information in different formats or times within the log-in process. This requires the user to remember different log-in procedures for each different target web site, or go through the entire log-in process each time he or she desires to access an account.

What is needed, therefore, is a network security system provides comprehensive management and control over the different identifier and password strings for multiple different target computers.

What is further needed is a network password management system that automates the system of logging in and processing password access for different target computers for a single user.

### SUMMARY OF THE INVENTION

An automatic log-in processing and password management system for on-line, electronic commerce systems is described. On a server computer, a log-in processing module receives relevant transaction information from a user and processes this information for transactions to one or more target computers. The log-in procedure for access to a secure area within the target computer is stored as a script executable by the password management system. The processing system monitors user accesses to a target computer of the one or more target computers. A password management system detects a password entry requirement to initiate the transaction. The password management system accesses the appropriate password from a pre-stored data storage to obtain the password corresponding to the user identifier for the specific target client computer. The password management system then executes the stored log-in script and automatically populates the password or other access code into the appropriate access program of the client computer based on the user identifier.

Other objects, features, and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements, and in which:

FIG. 1 illustrates a network that implements a client-server password management system, according to one embodiment of the present invention;

FIG. 2A is a flowchart that illustrates the interaction between a server-side password management module and a client-side password management module, according to one embodiment of the present invention;

FIG. 2B is a flowchart that illustrates the general steps of processing a password managed client access request, according to a method of the present invention;

FIG. 3 illustrates a password management system incorporated within an exemplary loan origination software system comprising several target partner computers, according to one embodiment of the present invention;

FIG. 4A is an exemplary web page for an automated password entry system with an automatic fill-in function, according to one embodiment of the present invention;

FIG. 4B is an exemplary web page for an automated password entry system displaying an automatic pop-up reminder window, according to one embodiment of the present invention;

FIG. 5 is a block diagram illustrating a document object model for the password management system, according to one embodiment of the present invention;

FIG. 6 is a flow chart illustrating a method of automatically processing a password protected web page entry according to the document object model of FIG. 5 for one embodiment of the present invention;

FIG. 7A illustrates a database table that links user names to user ID and password data, according to one embodiment of the present invention; and

FIG. 7B illustrates a database table that links target computer network addresses to automatic log-in scripts, according to one embodiment of the present invention.

### DETAILED DESCRIPTION OF THE PREFERRED EMBODIMENT

An automatic log-in processing and password management system for distributed electronic commerce applications is described. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of preferred embodiments is not intended to limit the scope of the claims appended hereto.

Aspects of the present invention may be implemented on one or more computers executing software instructions. According to one embodiment of the present invention, server and client computer systems transmit and receive data over a computer network or a fiber or copper-based telecommunications network. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the downloaded instructions may be directly supported by the CPU. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, nor to any particular source for the instructions executed by the server or client computers. In some instances, the client and server functionality may be implemented on a single computer platform.

Aspects of the present invention can be used in a distributed electronic commerce application that includes a client/server network system that links one or more server computers to one or more client computers, as well as server computers to other server computers and client computers to other client computers. The client and server computers may be implemented as desktop personal computers, workstation computers, mobile computers, portable computing devices, personal digital assistant (PDA) devices, or any other similar type of computing devices.

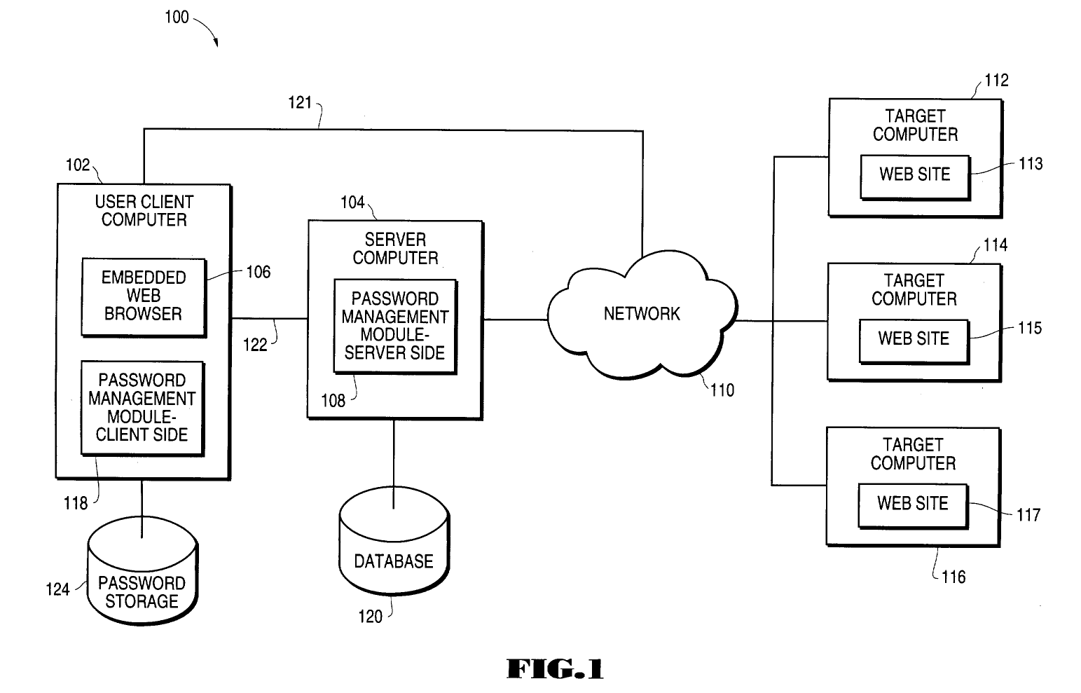

In a distributed network, such as a web-based Internet network, in which a user through a web browser enabled client computer can access many different web server computers, secure access to multiple different computers through password based systems requires centralized password management for efficient control. FIG. 1 illustrates a network that implements a password management system, according to one embodiment of the present invention. In system 100, a user client computer 102 accesses one or more target computers 112, 114, 116 over line 122 through server computer 104 and network 110.

For the embodiment illustrated in system 100, access to each of the target computers is restricted through security measures, such as user log-in and password based security. Thus, a user attempting to access or transfer data to/from any of the target computers must first provide a valid user identification and a password associated with that identification. This is typically implemented through the use of a unique account set up for the user on each target computer. Once a valid connection has been established between the user computer 102 and a target computers, communication between the user computer and target is accomplished directly over line 121.

In one embodiment, the network 110 is the Internet, and the interface between the user client computer 102 and/or server computer 104 and the target computers 112, 114, and 116 is a web-based interface. For this embodiment, each of the target computers executes a web server process to provide access to users through a web site. Thus target computer 112 serves web site 113, target computer 114 serves web site 115, and target computer 116 serves web site 117. The user client computer 102 includes a stand-alone or embedded web browser process 106 that allows the user to access the web sites served by the target computers. The web browser process can be implemented as a program such as Microsoft Internet Explorer™ or Netscape Navigator™.

The server computer 104 contains a server-side password management module 108 that processes password secure transactions and provides for automatic log-in to user accounts between the user client computer 102 and the target computers. The user client computer 102 is registered with the server computer 104 through an identifier that is referred to as the “client user name.” The client user name can be an identifier based on an account established between the server computer administrator and the user, or it can be based on a network address, or similar address. It should be noted, that in most cases, this identifier between the user client computer and the server computer is distinct from the identifier that is used between the user client computer and each target computer, which is referred to as the “user ID.”

The user client computer 102 executes a counterpart client-side password management module 118. It is assumed that each target computer has a unique account established for each user to access the target computer or initiate transactions between a particular user client computer 102 and the target computer. It is further assumed that each user establishes unique accounts for him or herself on each different target computer. This is often done by choosing different user identifiers and/or passwords for each target computer. Thus, for target computer 112, the user ID may be “JohnDoe” and the associated password may be “Red”; for target computer the 114, the user ID for the same user may be “JohnD” and the associated password may be “Green”; and for target computer 116, the user ID for the same user may be “JDoe” and the associated password may be “Blue”. In such a scenario, the user must remember and keep straight which user ID and password is used for each target computer.

Each target computer may also have specific log-in procedures that differ from the other target computers. This serves to further differentiate the access procedures on different target computers. For example, besides user ID and passwords, some accounts may require further information, such as account type, transaction type, and so on. Furthermore, each computer may require the user to input such information at different places within the log-in procedure. For example, some target web sites may request password information in the home page, while others may require the user to access separate log-in web pages that are accessed in one or two clicks from the home page. To allow for automatic log-in to these target accounts, the password management module 108 and/or 118 must be configured to recognize the log-in procedures required by each different target web site.

For each target web site within system 100, specific log-in procedures are stored within a database 120. For example, web site 113 on target computer 112 may simply provide a user ID field and password field within the home page of the web site. For this web site, the password management module can be programmed to identify the user ID field and the password field and supply the correct access steps, based on the stored log-in procedures, to log the user into the target web site. Another web site, such as web site 115 on target computer 114, however, may require that the user access a lower-level web page before providing user ID and password information for his or her account.

The user identifiers and associated passwords that are used by the user for each target web site are also stored in database 120. Thus, for each target web site, a log-in script and user ID's and passwords for different user accounts are stored in database 120. As illustrated in FIG. 1, database 120 may be closely or remotely coupled to the server computer 104. Alternatively, the password database may be maintained in a data storage 124 coupled directly to the user client computer 102 or to each or any one of the target client computers 112, 114, or 116.

In general process terms, the server-side password management module 108 processes a user access or transaction request to determine whether a password-based transaction is involved. If a password is required, the password management module identifies the target computer and the user who is initiating the process. The password management module then retrieves the password from the database 120 and provides it to the target computer for access. The password management module also determines the log-in procedure that is required to be performed by the target computer, and downloads it to the user computer for execution of the steps required to log the user into the appropriate target computer web page.

For the embodiment in which the user client computer 102 accesses the target computers through server computer 104, the server-side password management module 108 in server computer 104 is linked to a client-side password management module 118. The client-side password management module 118 is configured to monitor the user access to one or more of the web sites in the target computers. Through this monitoring function, the client-side password management module 118 can automatically detect accesses to target computers that require password access. When such a secure access is detected, the server-side password management module 108 accesses the log-in procedure steps stored in database 120 for the target computer, and pulls the user ID and/or password information from either the database 120 or the password storage location 124. The client computer 102 then executes the log-in procedure and automatically provides the password to the target computer to allow the user to seamlessly access the appropriate target computer. Depending upon the implementation of the log-in procedure for the target computer, the server-side password management may be configured to automatically perform the log-in procedure and cause the automatic inputting of the user ID and password to the target computer, or it may be configured to display a sub-window in the target computer web site that prompts the user to manually input the user ID and password information.

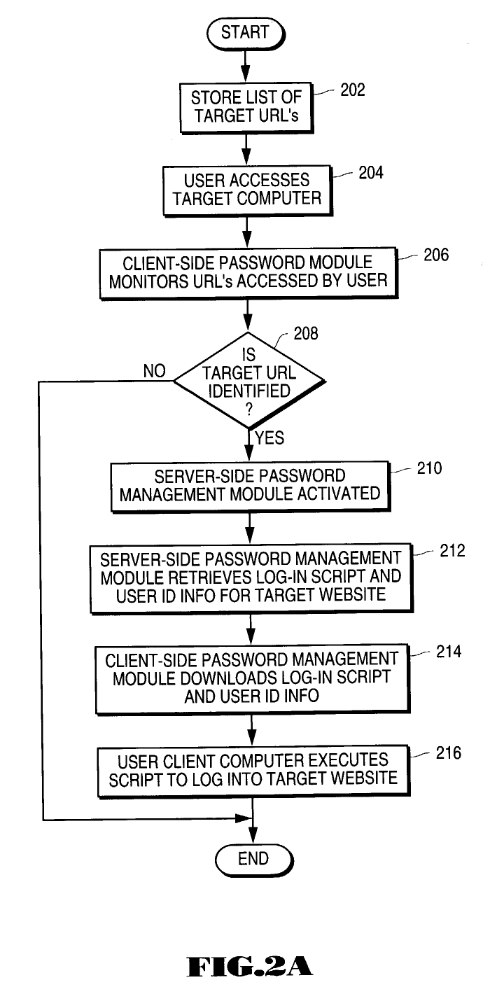

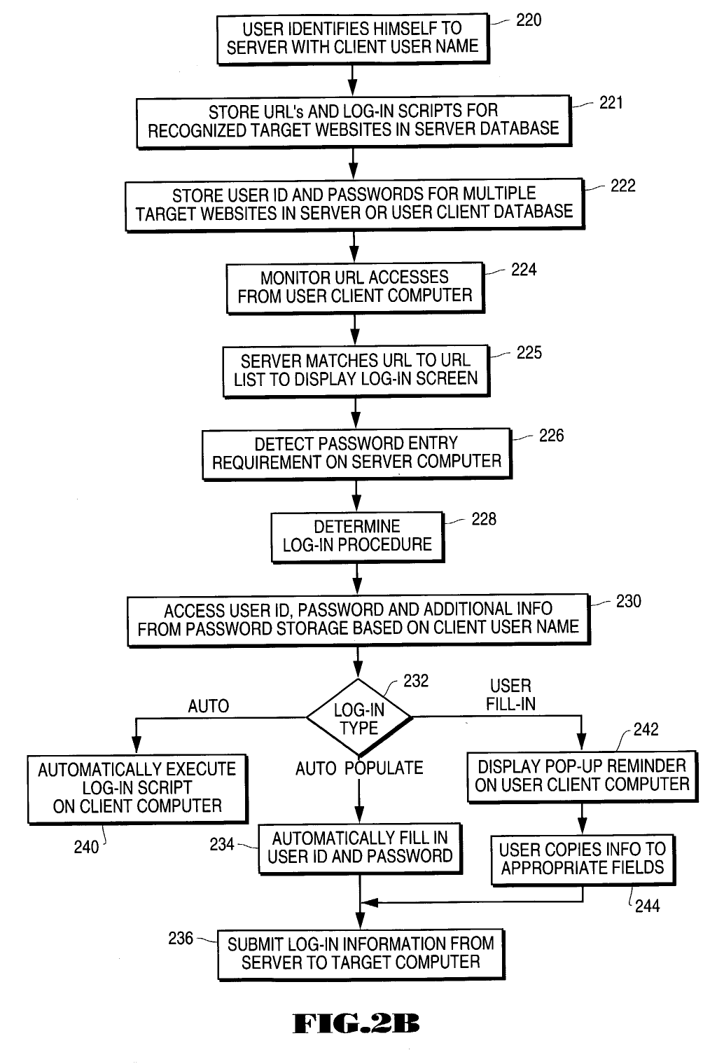

For the embodiment illustrated in FIG. 1, the log-in processing and password-controlled access from user computer 102 and the target computers 112, 114, and 117 is managed by the server-side password management module 108 and the client-side password management module 118. FIG. 2A is a flowchart that illustrates the interaction between the server-side 108 and client-side 118 password management modules, according to one embodiment of the present invention. In step 202, a list of target URL's that require password access and/or for which automatic log-in can be provided, is stored in database 120. This allows the user to specify particular target computers for automatic log-in processing and password access.

Whenever the user attempts to access any particular target computer, step 204, the client-side password management module 118 monitors these network addresses, step 206. The URL's accessed by the user are compared to the URL list stored in database 120. In step 208, the client-side password management module 118 determines whether the accessed URL corresponds to a listed target computer. If so, the server-side password management module 108 is activated in step 210. The server-side password management module 108 retrieves the log-in script for the target computer and the user ID and password information for the user, from database 120, step 212. The client-side password management module 118 then downloads the log-in script and user ID and password information, step 214. The user client computer 102 then executes the script to log into the target web site, step 216.

It should be noted that various alternative embodiments can be implemented with regard to where the particular target URL, log-in script, and user ID/password data can be stored and accessed by the server and client side password management modules. For the embodiment illustrated in FIG. 2A, the URL list of target computers is stored in database 120 coupled to server computer 104. Alternatively, this list can be stored or cached in memory accessible to user client computer 102, such as in password storage 124. The user ID and password information can also be stored in this database 124, rather than in database 120.

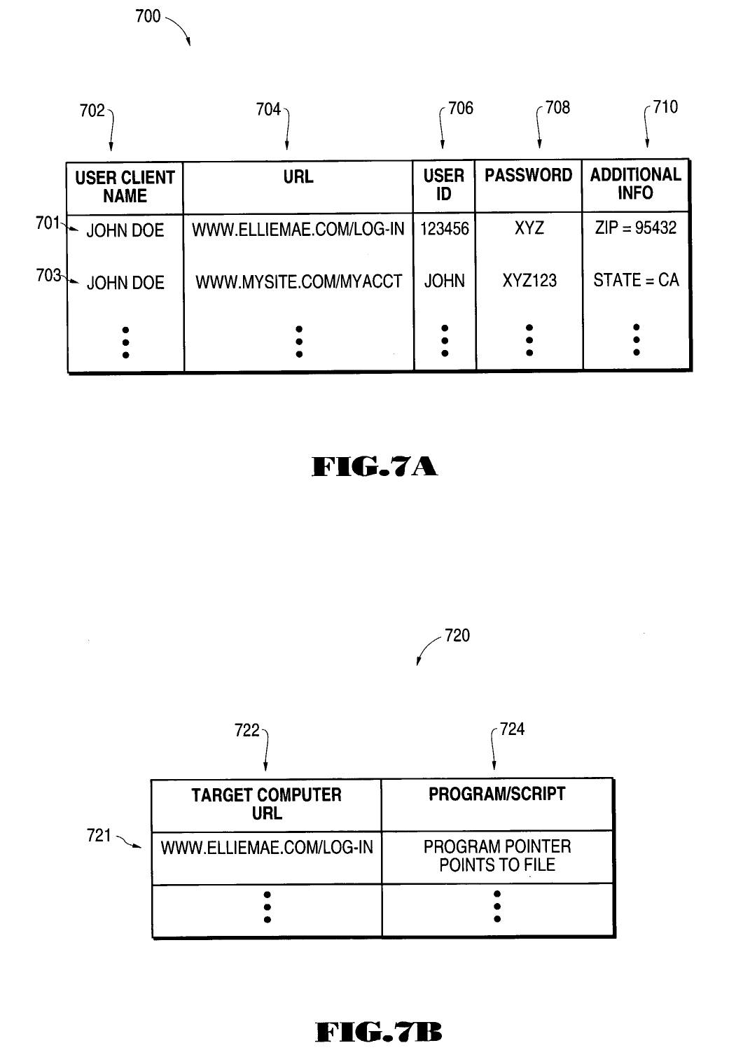

The format of the user ID, password, log-in script, and other information as stored in a database for an exemplary embodiment of the present invention is illustrated in FIGS. 7A and 7B. FIG. 7A illustrates the storage of user ID, password, and additional information data for a user with accounts on several different target computers. Table 700 illustrates the items of information that are stored for a particular user for different target computers. The stored information includes the user client name 702, the URL for the target computer 704, the user ID 706, the password 708, and additional information (if required) 710. For the example illustrated in FIG. 7A, the user client name as registered by the user with the server computer 104 is “John Doe.” The first table entry 701 for this user lists the URL of the target computer as “www.elliemae.com/log-in.” This corresponds to the log-in page for a web site maintained by the first target computer. The user ID set up by the user for this target computer is “123456” and the password is “XYZ”. Column 710 of table 700 provides an area for the storage of any additional information that may be required to log-in to the target web site. Here, the zip code may need to be entered during the log-in step to provide an additional means of validation. In this case, the server-side password management module 108 will provide this table entry to the client-side password management module 118, which will then input this data as required during execution of the log-in script. Table 700 also shows account information for user John Doe for a second target computer URL “www.mysite” 703. For this target web site, the user has the user ID “John”, password “XYZ123”, and some additional information. It should be noted that the information presented in FIG. 7A can be presented in various different ways, such as sorting by target computer URL, rather than by user client name, and so on.

FIG. 7B illustrates the exemplary storage of log-in scripts or programs for various different target computers in a database, according to one embodiment of the present invention. In table 720, the program/script 724 for each target computer URL 722 is provided in tabular form. The URL for the target computer, such as “www.elliemae.com” is listed in column 722, and the corresponding log-in script is accessed through the data present in column 724. In one embodiment, the program or script is an executable file that is pointed to by a pointer stored in table 720. In some other cases, the executable code itself may be stored in this table entry. The log-in script data stored in table 724, either the pointer or the code itself, is accessed by the server-side password management module 108 and downloaded to the client-side password management module 118 for execution, as illustrated in step 214 of FIG. 2A.

It should be noted that the data represented as stored in tabular format in FIGS. 7A and 7B can be stored in various different formats and/or structures, and by using different database, spreadsheet, or any similar type of index-based program. Some of the table entries may have sub-tables for fields. For example, the additional information column 710 in table 700, may include various different fields for each user name and/or URL depending on the number and type of different types of additional data that is required.

FIG. 2B is a flowchart that illustrates the general steps of processing a password managed client access request for automatic log-in to a target web site, according to a method of the present invention. For the method illustrated in FIG. 2, the access between user client computer 102 and target computers 112, 114, and 116 is through server computer 104 over line 122. The client-side password management module 118 and server side password management module 108 work in conjunction with one another to monitor user accesses, provide target web site log-in procedures, access user ID and password information, and log the user into the target web site, as explained above with reference to FIG. 2A.

As a preliminary step 220, the user accesses the server computer 104 and provides the appropriate client user name. In step 221, the target URL's and log-in scripts for the different target web sites are stored in the server database 120. This provides a basis for accessing recognized target web sites and performing automatic log-in for the user, as opposed to unknown web sites, or web sites for which the log-in procedure is not known. In one embodiment, the log-in procedures are stored as one or more executable script files that are executed for the user client computer.

In step 222, the user ID and password information for the multiple target websites are stored. Typically this information is stored in a centralized database, such as database 120. This database can be the same database or a different database than the one used to store the log-in procedures for step 221. The passwords can be stored by the user through the setup of accounts in each target computer. Alternatively, the passwords can be stored in a password storage location 124 coupled to the user client computer 102. The user client computer 102 initially accesses the various target computers through the server computer 104. The embedded web browser 106 provides web access for the user to web sites hosted by the target computers, either indirectly over line 122 or directly over line 121, once the automatic log-in and password processing procedure has been completed.

The client-side password management module 118 monitors the web accesses from the user client computer 102, step 224. Accesses to URL's that correspond to recognized target web sites and password protected target computers are flagged. This is performed by comparing the accessed URL to the URL list stored in the database, step 225. Processing of a recognized URL in step 225 causes the embedded web browser 106 to display the web page, typically the log-in screen, for the target computer. For these recognized target web sites, some accesses may not require password entry. For example, some websites may offer information or portal functions that do not require payment or usage restrictions. The server-side password management module 108 detects whether an access or transaction request requires that the user enter a password to continue, step 226. This is typically accomplished by receiving back from the target web site, a message that account information or other user validation is required for the request to be processed, or by recognizing the target web site URL as being one that has been identified by the password management system as requiring user validation.

In step 228, the log-in procedure for the target web site is determined. This is performed by looking up the stored log-in procedure for the URL corresponding to the target web site. For password-based access, the server-side password management module 108 retrieves the appropriate user ID and password from the database 120 (or password storage 124), step 230. The database can also store other additional information that may be required to complete the log-in process. The user ID, password, and additional information are catalogued in the database based on the client user name and the URL (network address) of the target computer. As shown in step 220, the client user name can be provided to the server computer upon initiation of the transaction, or it can be determined automatically by the server computer based on the URL or network address of the user client computer 102. In the latter case, it is assumed that the user has a pre-determined account or identifier established with the server computer 104.

In one embodiment of the present invention, three separate log-in procedures are available, depending upon the requirements, level of integration, and type of account implemented in each target computer. In step 232 it is determined whether automatic log-in and password processing is possible for the target web site. The highest level of integration between the target computer and the password management system allows for automatic log-in. For this type of system, the server-side password management module 108 accesses the log-in script for the target computer along with the corresponding user ID and password information. It then passes this data to the client-side password management module 118, which automatically executes the script and inputs any required user ID and password information to log into the target web site, step 240. The automatic log-in step 240 is done in a manner that is essentially transparent to the user, so that after user access to the target web site through the embedded web browser 106, the target web site is displayed on the user client computer 102.

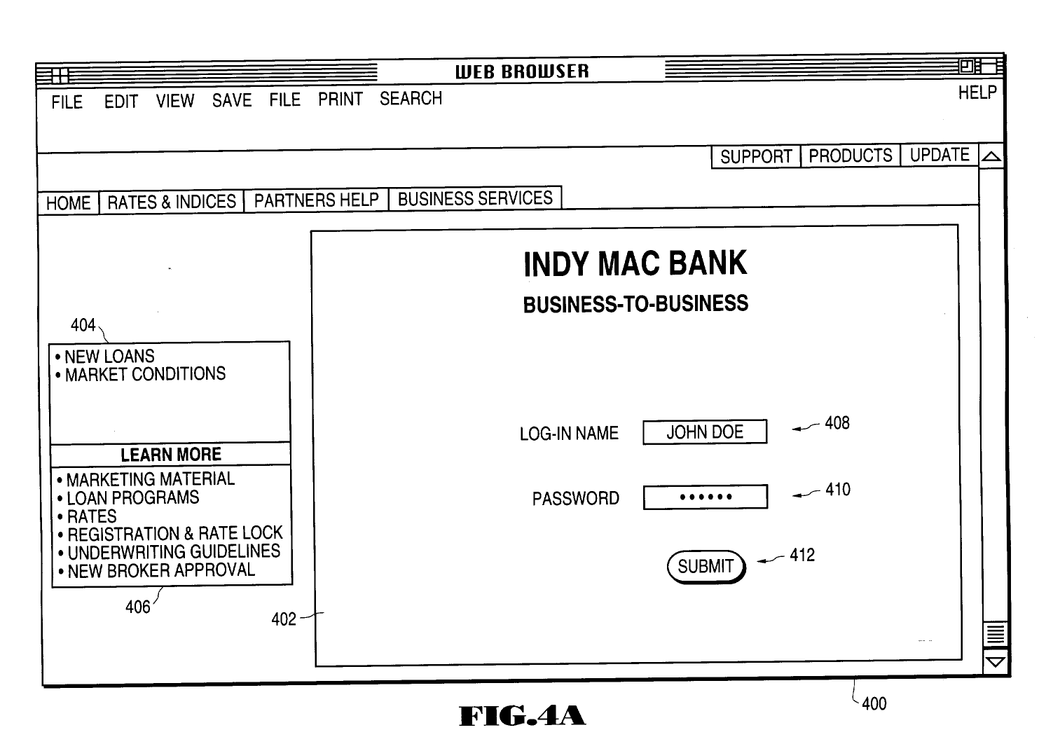

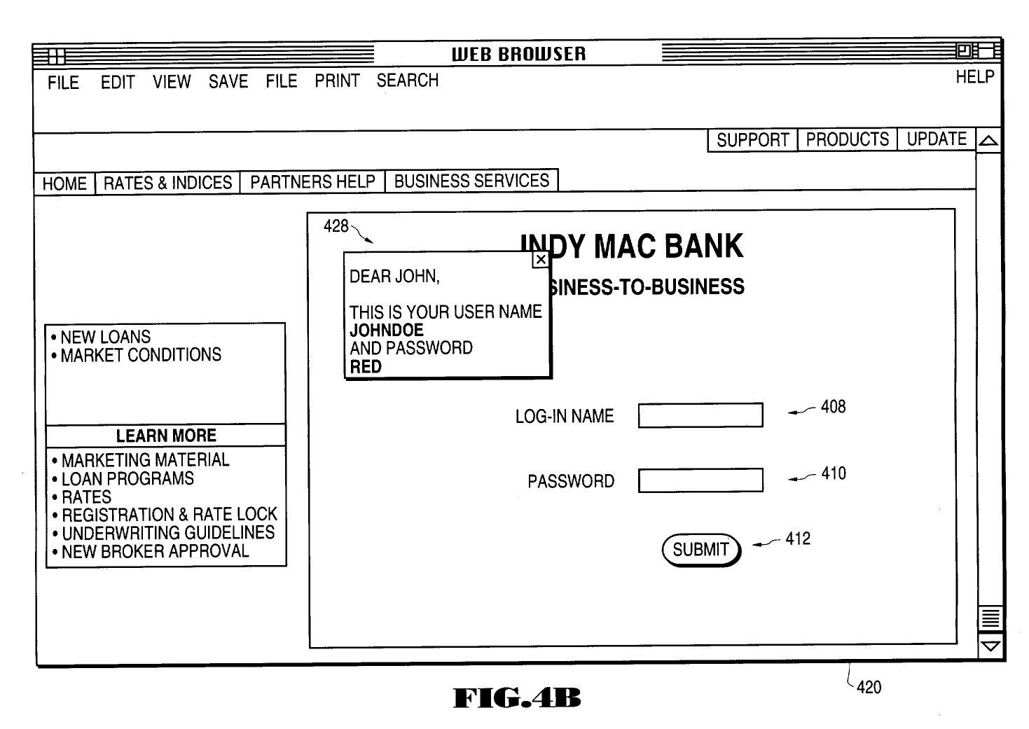

In a second log-in procedure, the server-side password management module 108 can be configured to automatically fill-in the user ID and password information in the appropriate log-in web page of the target computer web site. For this embodiment, the server-side password management module retrieves the user ID and password information corresponding to the target computer, step 216. The log-in web page that was caused to be displayed in step 225 typically consists of user ID and password input fields, as shown in FIG. 4A. In step 234, the password management module automatically fills-in the user identifier and password in the web page or other access area required by the target computer web site. This information is then transmitted from the server computer 104 to the appropriate target computer to log the user into the target web site, step 236.

FIG. 4A illustrates an exemplary web page for a target computer. In web page 400, a main display area 402 includes data input fields for the user's log-in name (ID) 408, and password, 410. In a typically manual operation, the user would access this web page directly from the user client computer 102, and then manually enter the information into these fields. Certain web sites may allow a user to enter only one item of information, such as log-in name, and then automatically provide the password. However, this system still requires that the user directly access the web site and input the appropriate data. For the automatic fill-in process illustrated as steps 234 to 236 in FIG. 2, the server-side password management module 108 allows for the automatic display, inputting and transmission of user identifiers and associated passwords through the determination of target computer network address and user computer network address. It should be noted that for the embodiment in which the log-in procedure is automatic, as shown in step 240, the user ID and password fields illustrated in FIG. 4A may not be displayed on the user computer.

In the third log-in procedure illustrated in FIG. 2, manual log-in steps may be provided for systems in which automatic log-in is not available. The server-side password management system transmits a message or indication alerting the user that manual log-in and password entry is required. Since user ID and password information is often required, the server-side password management module 108 causes a “pop-up” style reminder window to be displayed on the log-in page, step 242. This window provides the user with the stored user ID and password information. The user can then type this information into the appropriate fields of the log-in screen, step 244. This information is then submitted from the server to the target computer, step 236. This log-in procedure can be utilized in cases where the user needs to be reminded of the user ID and password information, or when the user may need to provide information other than the user ID and password that the system does not have stored, such as additional user account or profile information. Additionally, this mechanism may be used when the system requires that special procedures be followed to access the target web page, such as specific URL paths to follow.

FIG. 4B illustrates a pop-up reminder window 428 displayed against the background web page 420 for an exemplary target web site, for the embodiment illustrated in steps 242 to 244 of FIG. 2. For this embodiment, the user is reminded of his or her user ID and password, and any other relevant information. The user can then input this data into the appropriate fields of the log-in screen. Once the information is provided by the user, he or she can submit the log-in information to cause the log-in information to be transmitted from the server computer to the target computer, step 236.

In one embodiment, the password management system illustrated in FIG. 1 is utilized in an on-line loan application process that utilizes a centralized loan origination system. Such a system is described in U.S. patent application Ser. No. 10/172,844, entitled “Online System for Fulfilling Loan Applications from Loan Originators”, filed on Jun. 14, 2002, and which is incorporated herein by reference.

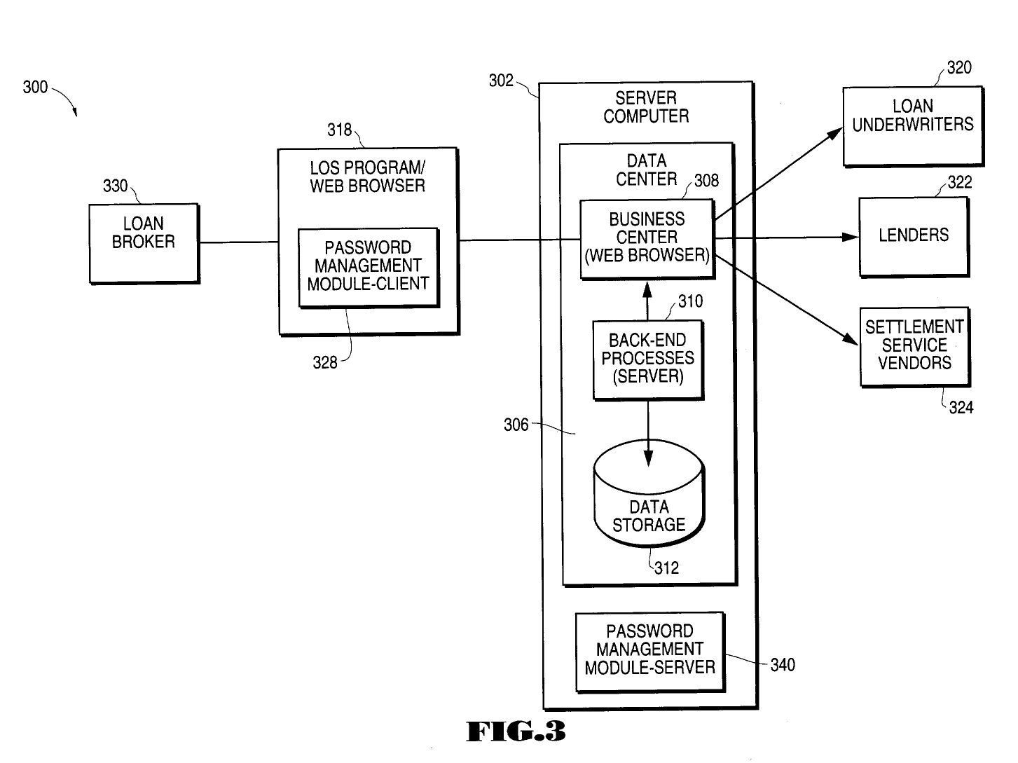

FIG. 3 illustrates an on-line loan application network that implements embodiments of the present invention. Computer-based loan brokers typically use sophisticated programs, referred to as Loan Origination Software (LOS) systems, to automate the loan application process and fulfillment process. In a traditional loan application scenario, a borrower approaches a loan broker to find an appropriate loan. The broker takes the application information from the borrower and compiles a traditional loan application. Some type of loans provide standardized formats for the loan application information. For example, mortgage loan applicants and processors typically use a uniform mortgage application form to provide what is referred to as “1003” data, corresponding to FNMA (Fannie Mae) form number 1003. The loan broker then passes the application information to various other parties, such as loan underwriters, lenders, and settlement service vendors.

Network 300 allows use of the Internet to provide computerized processes as viable and promising vehicles with which to conduct business. Traditional loan processing involves a great deal of customer support, data input, and expedited mailing and delivery of physical documents. These factors present areas of great cost and potential problems in the loan application, processing, and delivery transaction. In the loan application process of system 300, a broker matches a borrower (customer) with the loan package that best suits their need. Unlike the retail loan market, in which the borrower directly inquires about loans available from a bank or commercial lender, the loan broker utilizes the wholesale loan market. In terms of a general process, the broker obtains data from the borrower and then shops for loans from the available sources in the wholesale loan market. Wholesale lenders typically work only with brokers, and take completed loan packages and underwrite them. The brokers are typically offered discounted pricing in return for the processing work performed by the broker.

In a network embodiment of the present invention, a loan broker computer is configured to access computers operated by third parties (typically in the wholesale loan market), such as lenders, loan underwriters, settlement service vendors, and other similar loan fulfillment parties through a web based interface that is integrated with a loan origination software program. The loan broker provides an on-line interface between borrowers, and those companies that will ultimately perform the loan services and provide the requested funds. During the course of the loan application process, various items of information are transmitted among the parties, including borrower information and loan application data. This information is typically maintained in databases stored in the broker computer, or on the third party computers. Different entities may be responsible for different aspects of the transaction from the lender's side. For example, one company may be involved in the processing of a loan application, while another is involved with providing the loan itself, while yet another may be involved with the billing and collection of repayment from the borrower.

The network implementation facilitates the delivery (transmission) and tracking of data and allows for the completion of electronic commerce transactions. Several different network topologies may be implemented through the use of a loan processing network system according to embodiments of the present invention. In general, the network system couples one or more lenders (banks, financial institutions, credit agencies and so on) to the loan brokers who act on behalf of potential borrowers. The loan brokers help borrowers to find and obtain loans by obtaining personal data from the borrower, searching for compatible loans from the various lenders, presenting loan selections to the borrower, and performing certain validation or screening tasks, such as pre-qualification of the borrower. The loan brokers also directly interface with the parties that will fulfill the loan or provide settlement services, such as lenders, loan underwriters, and settlement service vendors.

A broker typically keeps track of pending loans and customers through one or more pipelines. A pipeline generally refers to a list of all loans and/or borrowers that are committed and being processed by the broker. A separate pipeline, often referred to as a “pre-qualification pipeline” can be used to list prospective loans and/or borrowers who are not yet committed to a particular loan.

For purposes of the present discussion, a loan originator is any person or entity that helps to procure a loan on behalf of a borrower, and can include loan brokers, loan officers, loan processors, correspondent brokers, small banks that provide brokerage services, and any other similar type of loan procurement company or personnel. As used herein, the term “loan broker” is used to represent any such type of loan originator.

Loan brokers typically execute Loan Origination Software (LOS) programs to manage the origination tasks in the loan application process for a borrower. In one embodiment of the present invention, a processing and submission system is embedded in a server computer system that is closely coupled to or integrated within the loan origination system program on the broker desktop. This integration serves to streamline the loan submission process and provides seamless connectivity to lenders and settlement service vendors over the network. The processing and submission system provides a direct interface to the loan origination system programs and allows efficient management and transmission of file data present in the broker loan origination software to the lender and vendor computer systems. The processing and submission system thus provides a centralized and comprehensive system for compiling the loan and borrower information, populating the loan documents with the relevant data, and submitting the completed documents to the appropriate lender and other third parties for review. This allows the broker to capture the borrower data once and publish this data to multiple lenders without having to repeatedly enter the borrower data for each loan application.

FIG. 3 illustrates an exemplary network system for processing loan applications, according to one embodiment of the present invention. In FIG. 3, a loan broker 330 uses a loan origination system or stand-alone web browser system 318 to access the server computer. The server computer executes several program modules that manage the loan origination process. The main module comprises a data center that, when executed on the loan broker computer, comprises a system referred to as the “broker desktop environment.” Integrated in the server computer 302 is a web browser program 308 that serves as a gateway to connect the desktop to a business center process, one or more back-end processes 310, and a data storage facility 312.

In one embodiment, the business center 308 contains a network interface that provides access between the loan origination system program 318 and other entities. For the embodiment in which the network comprises the Internet, the interface may be a web-based interface. In this case, the business center 308 includes a web browser client process executed on the loan broker computer. In one embodiment, the web browser program is implemented using Microsoft® Internet Explorer™ browser software. The back-end processes 310 comprise the processing and submission system servers that provide downloadable program modules to the loan origination program and/or perform calculations for the loan origination program. The data storage facility 312 stores various data related to the lenders and users within the system.

The business center process 308 within the data center includes the software module comprising the processing and submission system, according to embodiments of the present invention. The business center implements business and processing logic modules for receiving loan application information from a borrower (such as 1003 data for mortgage loans), storing data related to the borrower, providing interfaces to processes utilized by lenders and other third parties that fulfill and settle the loan. In this manner, the program modules required for the processing and submission system, as well as the interface to the third party entities is embedded directly within the loan origination software executed on the broker computer.

As illustrated in FIG. 3, the loan origination system program 318 on the broker computer is coupled through the business center process 308 to loan underwriters 320, lenders 322, and one or more settlement service vendors 324. These entities perform the function of fulfilling and settling the loan application. These entities generally access the loan origination system program of the broker computer through the web browser interface of the business center 308. The business center 308 also provides facilities to set up storefront type interfaces for lenders to customize their offerings, and provides an information portal for brokers.

One or more of the loan underwriters 320 reviews the loan application and approves or denies the application. One example of a mortgage loan underwriter is the Fannie Mae company, which does not itself provide loan funds, but instead works with lenders to assure that the funds are available. Lenders 322 are banks, savings and loans, or other financial institutions that provide the loan funds. The settlement service vendors provide services and information required to close the loan. Such vendors include appraisers, credit reporting agencies, document preparers, flood certification agencies, and the like. Other third party entities that may be interfaced to the broker computer may include loan servicers who collect monthly payments from the borrower, and other similar loan process companies.

The loan origination software system 318 utilized by the loan broker can be a proprietary system or a commercially available system. As illustrated in FIG. 1, the loan broker may be coupled to the target web sites either directly or indirectly through the server computer. For the embodiment in which the broker is coupled directly, the LOS program 318 includes an embedded web browser process and a client-side password management module 328. FIG. 3 illustrates an embodiment wherein the network interface (web browser) is embedded within the server 302. For this embodiment, the loan origination system software may be a program such as Genesis™, or Contour™, which are trademarked products of Ellie Mae® Corp. In the alternative embodiment, the network interface may be closely coupled to, rather than embedded within the loan origination software.

For the system illustrated in FIG. 3, most vendor transactions processed through the loan origination system 318 require an account to be established with the lender, vendor, or other third party prior to submission. This in turn, requires that the user define unique passwords for each account. To eliminate the multiple user identifier and password combinations that the user needs to remember, the log-in information is saved by the password management process 340 of the server computer 302. The graphical user interface for the loan origination system can include an interface that displays the various password managed accounts, and provides sub-displays allowing the user to define and modify password and account identifier information for each account.

The different target web sites 320, 322, and 324 may also each require different log-in procedures to access the appropriate log-in pages. The log-in procedures are defined and stored by the password management process 340 of the server computer 302. Both the password and log-in information, as well as the log-in procedure information may be stored in data storage 312 within server computer 302, or in a separate memory storage device coupled directly or indirectly to either loan broker computer 330 or server computer 302.

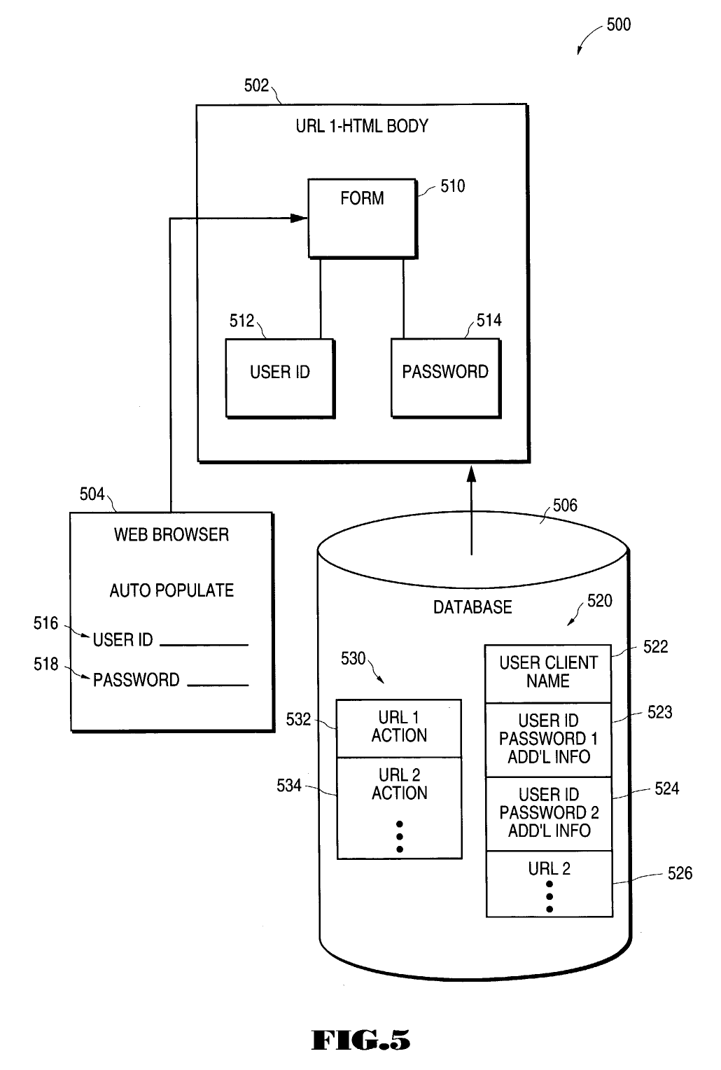

In one embodiment of the present invention, the server-side password management module 340 dynamically builds the link to the target web site to incorporate or otherwise access the user identifier and password information. For this embodiment, a document object model for the HTML data comprising the target computer web site is utilized. FIG. 5 is a block diagram illustrating document object model for the password management system, according to one embodiment of the present invention. In system 500, the HTML data for the target web page for the specified URL (URL 1) is illustrated as HTML body 502. This page includes form data 510 that is accessed upon transmission and processing of the appropriate URL link 510. The web page 502 includes modules for processing the user ID 512 and password 514 that allows the user to access or otherwise use the web page. The web page 502 is accessed by the user through web browser 504. The password management module 340 illustrated in FIG. 3 provides a process that allows for the auto-population of the user ID 516 and password 518 entries on the web page. Such a web page is illustrated in FIG. 4A.

The auto-population function is provided by the storage of the pre-defined user ID and password information in database 506. User inputs of web access are monitored by the client-side password management process 328, and the input of a particular URL for a targeted web page triggers the server-side password management module 340. This provides a dynamic password management function based on the user input URL. For each target web site, the corresponding user ID, password, and any additional information is stored in database 506. Thus, for URL1 522 that corresponds to web page 502, the user ID, password, and additional information for a first user 523 is stored, as are the user identifiers and passwords and additional info for second and third users 524 and 525. The database 506 can also store different user identifier and password information for other web sites, such as URL2 526. In this manner, the password management system can process user accesses from various users to various different web sites. As opposed to a static model, in which the web page stores user identifier information for a particular user and auto-fills the user ID through pre-stored information such as caches or “cookies”, the password management system of the present invention dynamically provides user identifier information through recognition of target web site URL's and individual database storage. The dynamic model illustrated in FIGS. 3 and 5 is also more secure than conventional models, since users must first register with the password management module. Network transactions between the server computer and the user client computers is accomplished using secure network protocols, such as HTTPS (secure hypertext transport protocol) to ensure robustness of the sensitive password data.

The automatic log-in function is provided by the storage in table 530 of specific action information associated with each recognized target web site. Thus, for URL 1, a specific log-in script 532 is stored, and for URL 2, a specific log-in script 534 is also stored. Upon access to a recognized web site referenced by a URL, the associated script is accessed from table 530 and executed by the password module. If the log-in procedure allows for the automatic filling-in of the password and user ID, as shown in steps 209 and 211 of FIG. 2, the appropriate user ID, password, and any additional information, are pulled for the target URL are pulled from table 520 in database 506 for automatic entry into the web page. The format of representative database tables is illustrated in FIGS. 7A and 7B. An exemplary table corresponding to table 520 in FIG. 5 can be represented by table 700 in FIG. 7A, and an exemplary table corresponding to table 530 in FIG. 5 can be represented by table 720 in FIG. 7B.

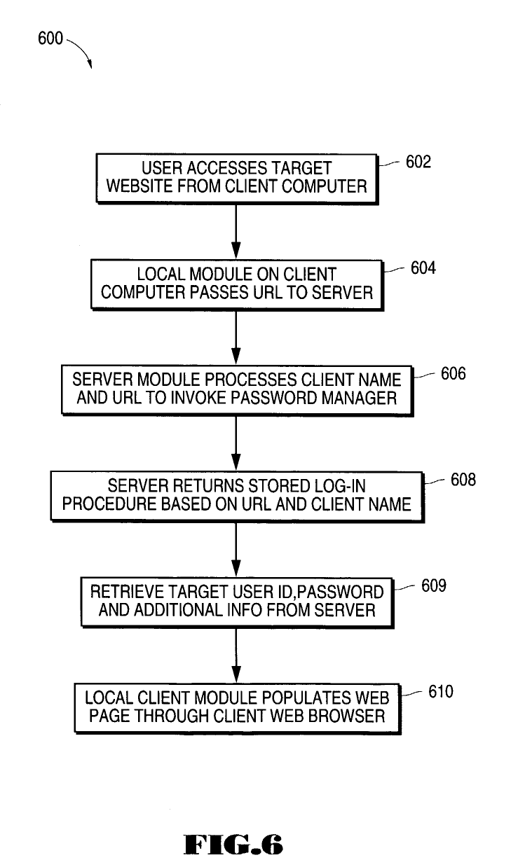

FIG. 6 is a flow chart illustrating a method of automatically processing a password protected web page entry according to the document object model of FIG. 5 for one embodiment of the present invention. In step 602, the user accesses the target server web site from the client computer. The local module on the client computer then passes the target URL to the server, step 604. The server-side password management module recognizes the URL as a password managed access for which the user is a valid and subscribed member. Thus, in step 606, a module on the server processes the client name, which registers the user with the server computer, to invoke the server-side password management module. In one embodiment, the client name can be recognized from the network ID, such as the TCP/IP address transmitted from the user with the URL request. Alternatively, the user can log-on to the appropriate interface of the server computer to provide registration or account information to access web sites accessible from the server computer, or an account previously set up on the server computer under the client name.

The client process may pass every URL requested directly to the server. Alternatively, the client process may cache a URL list of targeted computers in a local memory location. In this case, the client-side password management module first checks the cache to determine whether the target URL is stored in the cache. In this case, the client process does not need to pass the URL to the server for the server to detect a target web site hit.

The server performs a database look-up operation and, in step 608, returns the stored log-in procedures required by the target web site. In step 609, the user ID, password, and any additional information corresponding to the client name for the target web site URL accessed by the user is retrieved by the server from the password database, e.g., either in password storage 124 or database 120. Thus, as shown in FIG. 5, for URL1, the data returned for the first user would correspond to user ID, password1, and additional information 523, and log-in script or instructions 532. The local client module then populates the web page through the client web browser, step 610. This is illustrated in FIG. 5 as the autopopulate module in web browser 504.

Although embodiments of the present invention have been described with reference to a network implementation comprising the Internet and Internet-related web browsing and web serving technologies, it should be noted that alternative embodiments of the present invention can be implemented on many other types of networks and network protocols, such as proprietary protocols for local area networks, wide area networks, and any combination thereof.

The present invention has been described primarily in relation to loan applications for personal home mortgage loans. It should be noted, however, that many other types of loans can be processed through the embodiments described herein, such as commercial loans, any type of personal loan, home equity loans, and the like. Furthermore, embodiments of the present invention can be extended to other e-commerce transactions and models, other than on-line loan processing.

In the foregoing, a system has been described for managing and processing and password secure accounts in, for example, an on-line loan processing interface system. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A password management system for providing secure access from a user computer to one or more target computers, the system comprising:
a web server module on a target computer of the one or more target computers providing access to a web page on the target computer, the web page accessible through an unique uniform resource locator defined by a network protocol;
a web browser application resident on the user computer providing access to the web page from the user computer;
a database coupled to the user computer and configured to store a user identifier and a password for access by a user to the web page, and a log-in procedure required to allow user access to the web page;
a password management module coupled to the user computer and configured to recognize an access to the web page as a password secured access requiring input of the user identifier and password for the user, obtain the log-in procedure information for the web page, execute the log-in procedure, and pass the user identifier and password to the target computer upon execution of the log-in procedure.

2. The system of claim 1 wherein the password management module is resident on an intermediate server computer coupled between the user computer and the target computer.

3. The system of claim 2 wherein the database is stored on the intermediate computer.

4. The system of claim 3 further comprising an automatic form fill process coupled to the web browser, and configured to automatically input the user identifier and password data into appropriate data entry fields of the web page upon execution of the log-in procedure.

5. A method for processing and submitting password secured request to a web page served by a target computer from a user computer loan application data over a computer network, the method comprising the steps of:
storing in a first database, a user identifier and password for the user corresponding to an account established to allow access to the web page served by the target computer;
storing in a second database a log-in procedure for accessing a user account through the web page served by the target computer;
receiving an access to the target computer from the user by processing a uniform resource locator request from the user;
recognizing the uniform resource locator request as an access requiring password authorization;
identifying the user through a network protocol;
executing the log-in procedure;
retrieving the user identifier and password for the requested uniform resource locator for the user; and
automatically inputting the user identifier and password for the user in the web page displayed by the web browser.

6. A log-in management system for providing secure access from on a distributed client/server computer network in which a client computer is coupled to one or more target computers through a server computer, the system comprising:
an embedded web browser process resident on the client computer for accessing a web page hosted by a web server process resident on a target computer of the one or more target computers;
a first client-side log-in module executed by the client computer operable to monitor accesses by the client computer to the one or more target computers, and determine whether the network address of the target computer is within a list of network addresses for the one or more target computers;
a server-side log-in module executed by the server computer operable to retrieve log-in program script and user identifier information for a user of the client computer if the network address of the target computer is within the list of network addresses for the one or more target computers; and
a second client-side log-in module executed by the client computer operable to download the log-in program script and user identifier information from the server computer and execute the log-in script to affect user access to the web page hosted on the target computer.

7. The log-in management system of claim 6 wherein the user identifier information comprises a user log-in name established by the user for the target computer and a password uniquely identifying the user to the target computer.

8. The log-in management system of claim 7 further comprising:
a first database stored within a server memory storage coupled to the server computer; and
a second database stored within a client memory storage coupled to the client computer.

9. The log-in management systems of claim 8 wherein the user identifier information and log-in program script are stored in the first database.

10. The log-in management system of claim 8 wherein the user identifier information is stored in the second database and the log-in program script is stored in the first database.

11. The log-in management system of claim 8 wherein the list of network addresses for the one or more target computers comprises a list of Uniform Resource Locator identifiers stored in the first database.

12. The log-in management system of claim 11 wherein the web page on the target computer comprises a user account log-in page for the target computer, and wherein the server-side log-in module is operable to display the user account log-in page through the web browser on the client computer.

13. The log-in management system of claim 12 wherein the user account log-in page includes data entry fields for one or more data items identifying the user to the target computer, and wherein the second client-side log-in module inputs the user log-in name and password information into appropriate data entry fields of the user account log-in page.

14. The log-in management system of claim 12 wherein the user account log-in page includes data entry fields for one or more data items identifying the user to the target computer, and wherein the server-side log-in module causes a reminder window to be displayed on the user account log-in page, the reminder window displaying the user log-in name and password to facilitate direct user input of the user log-in name and password information into appropriate data entry fields of the user account log-in page.

15. The log-in management system of claim 8 further comprising a third database storing a client name identifying the user to the server computer, the third database being stored within the server memory storage.

16. A log-in management method for providing secure access from on a distributed client/server computer network in which a client computer is coupled to one or more target computers through a server computer, the method comprising:
storing a list of Uniform Resource Locators for target computers in a first database;
registering a user of the client computer with the server computer through a client name;
establishing an account for the user on the target computer through a user name and a password;
storing the user name and password in a second database;
storing log-in procedures for each target computers for which a Uniform Resource Locator is on the list of Uniform Resource Locators in a third database;
monitoring accesses by the user to the one or more target computers;
determining whether an access to a target computer of the one or more target computers is to a Uniform Resource Locator stored on the list of Uniform Resource Locators;
retrieving the log-in procedure corresponding to the target computer and the user name and password corresponding to the user if the target computer Uniform Resource Locator is on the list of Uniform Resource Locators, and downloading the log-in name, user name, and password to the client computer; and
executing, on the client computer, the log-in procedure to enable the user to access the target computer.

17. The method of claim 16 further comprising the step of automatically entering the user name and password data into corresponding data entry fields on a log-in web page of the target computer.
